(19) United States
(12) Patent Application Publication
(10) Pub. No.: US 2001/0041988 A1
(43) Pub. Date: Nov. 15, 2001

(54) Customer renders seller issued incentive-voucher to after-sales service providers to enhance service quality

(76) Inventor: Bo-In Lin, Los Altos Hills, CA (US)

Correspondence Address: Bo-In Lin, 13445 Madoli Drive, Los Altos Hills, CA, 94022, US

(21) Appl. No.: 09/851,793

(22) Filed: May 8, 2001

Related U.S. Application Data
(60) Provisional application No. 60/203,154, filed on May 9, 2000.

(51) Int. Cl. G06F 17/60

(52) U.S. Cl. 705/1; 705/26

(57) ABSTRACT

The present invention is a method for transferring electronic vouchers over a network system for defining and rewarding an after-sales service and customer care activity. In a preferred embodiment, the method further includes a step of transferring an incentive electronic voucher for payment of an assessment of customer satisfaction.

This Formal Application claims a Priority Date of May 9, 2000 benefited from a previously filed Provisional Application 60/203154 filed on May 9, 2000 with an attorney docket number LC&SJ2K02 by the Applicant of this Formal Patent Application.

### BACKGROUND OF THE INVENTION

1. Field of the Invention

This invention relates generally to method and apparatus for providing after sales services for commercial transactions carried out between cybernetic entities through network for carrying out electronic commerce. More particularly, this invention is related to methods and apparatus to effectuate customer-driven voucher-payment system with redeemable incentive voucher paid to after-sales service and customer care (ASCC) providers to enhance the service quality.

2. Description of the Related Art

As more activities of electronic commerce are carried out with buyers now receive goods or service ordered from cybemetic-net stores shipped by specialized shipping companies, the need for an after sales services becomes a major problem if the goods or services are not satisfactory. The “virtual seller” typically has no physical presence near the buyer. Other than some large corporations, such as Dell computer, pre-arranged services programs to take care after sales issues are generally not made specifically available. The technical support or customer service departments are typically assigned to handle the processes to carry out the after sales services. However, to a customer, repeated telephone calls and holding on to the telephone line for long period of time to wait for next available customer service agent by are often experienced. Even a phone call is made and discussion with a customer service agent is completed, the required services may not be properly carried out because there are no direct communication between the customer and those directly involved in carrying out the necessary after-sales services. There are often mismatches between what are promised by the customer service agent and the understanding of a technician or clerk who handles the required services for the customer. Generally, there is no single person in charge of the entire process with whom a customer can directly communicate and rely on to complete the tasks. And, even if there is such a person, there is often no clearly defined tracking system to assure such processes are properly carried out to make sure the customer's after-sales needs are satisfied.

Because of these situations, a buyer who needs the after sales services, including but not limited to return the goods and cancel the order, often struggles with very frustrating situations. Under most circumstances, a customer relies on the diligence of the customer service agent to receive correct and complete information regarding the after-sales services. If the agent is not knowledgeable or unwilling to serve, due to the situation that there is no clearly tracking system of the development of the entire processes, the customer is left in the dark what will occur next. Further difficulties arise from the “true reality” that the seller is a virtual seller with no local physical presence. Contacts made to such stores in attempt to resolve the after sales problems are often ignored and not well responded by the sellers especially if these stores are small businesses unprepared to deal with the after sales demands. Such concerns may often become an intimidating factor preventing a potential buyer to order goods or services from a store through a sales program offered on the Internet unless that store is well known.

Large companies such as Compaq Computer are offering after sales services through Radio Shack stores to handle the after repair jobs. Microsoft offers nine-hundred (900) service line for user of Microsoft products to call and asking questions with a special higher rates of telephone charges. However such programs are only useful to larger companies with greater financial resources to set up service contact with a chain stores or a technical service provider company. Great number of business entities set up their store front in the cybernetic space and transact business over the Internet have no financial resource to easily resolve these concerns to relief the frustrations faced by those buyers who have to deal with the after-sales service problems. Additionally, under the current arrangements of either Compaq or Microsoft, the service providers are not driven by any substantial incentives to improve services other than to fulfill the contract requirements between the service providers and Compaq and Microsoft.

In addition to the frustrations and helplessness of a buyer in seeking after sales services, many different kinds of disputes between buyers and sellers are generated because the remote, random and unmanaged situations faced by both the seller and buyers in handling the situations. The disputes arise from misunderstanding and differences in expectations take up much time, and energy, and waste unnecessary manpower and resources in trying to resolve these disputes. The difficult situations all arise due to the lack of a system to manage the process and to motivate high quality after-sales services.

Furthermore, due to the random and unmanaged situations in handling the after-sales services and customer care, the cost structure for the sales of goods must somehow include the expected cost of carrying out the after sales services. However, as it is often difficult to quantify the costs that would involve in the after sales services, margins have to be built in to cover the unknown cost factors. The competitiveness and market efficiency suffer because of the uncertainties involved in the cost models. All these difficulties cannot be resolved even with current state of art of the electronic commerce where information and transactions can be instantaneously recorded and transferred over the Internet system. With current systems, the database with all aspects of transactions logged as electronically accessible files, do not appear to provide a means for improving the situations to better provide the after-sales services.

Therefore, a need exists in the art of electronic commerce to provide apparatuses and methods by making use of the electronic available communication and database accessibility capability to more clearly defined the after-sales service programs. On the one-hand it is desirable for a seller to have better cost basis to quantify the costs involved in after sales services. On the other hand, it is also desirable to enable a customer working together with the seller and the after-sales service providers to control, manage, and track the schedule and quality of after sales services with a clearly defined tracking system and efficient procedures.

It is also desirable that a customer is provided with incentive based voucher to reward an after-sales service provider for different levels of service quality. Particularly, if a customer prefers to deal with persons physically presented to perform the after-sales services, special vouchers can be used to reward an after-sales service provider with physical presence to serve the customer with special personal cares.

### SUMMARY OF THE PRESENT INVENTION

It is therefore an object of the present invention to provide new and improved systems and methods to facilitate more clearly defined processes and transactions between a seller, a buyer and a service provider such that the after sales services can be better managed. The cost incurred in each step of the processes can be more definitely quantified, and the entire process can be tracked with a specified tracking system, such that the difficulties and limitations for after sales service commonly encountered in transactions conducted with conventional electronic commerce can be resolved.

Specifically, it is an object of the present invention to provide systems and methods to enable a seller to provide options for a buyer to select different levels of after sales services and customer care (ASCC) programs for different prices. The selection options may include an option to purchase different ASCC vouchers for different ASCC programs with quality incentive vouchers payable to ASCC providers such that the buyer has an option to encourage and reward good quality of after sales services.

Another object of the present invention is to provide systems and methods to enable an online customer to log on an ASCC center that connects the customer to an ASCC provider to carry out a virtual direct communication. The customer can make online arrangement with the ASCC provider to carry out the ASCC program and to transfer vouchers to the ASCC provider for the ASCC provider to receive payment from the online GSP. The after sales services and customer care activities can be scheduled and arranged between the customer and ASCC providers without requiring the customer to carry out a separate search to locate the local ASCC providers for carrying out various ASCC tasks.

Briefly, in a preferred embodiment, the present invention discloses a network system includes an online goods and services provider (GSP) selling goods or services to an online customer through the network system. The online GSP further allows the customer to select an after sales service and customer care (ASCC) program. The network system further includes an after-sales service and customer care (ASCC) center for issuing a set of ASCC vouchers defining an ASCC program related to the goods and services transmitted over the network to the online customer to store in the customer's computer. Each of the ASCC vouchers further provides a link for linking the customer through the network to the ASCC center. The ASCC center provides a list of ASCC provider near the customer for the customer to choose a selected ASCC provider. The ASCC center provides a virtual direct communication between the customer and the selected ASCC provider for the customer to arrange with the ASCC provider to perform the ASCC program and transfer a set of program-related ASCC vouchers over the network the ASCC provider. The selected ASCC provider then transfers the program-related ASCC vouchers to the online GSP provider for payment of the ASCC program performed for the online customer. The ASCC center then sends a reminder over the network to the online customer to request a set of incentive vouchers for the selected ASCC providers for rewarding the selected ASCC provider according to a level of customer-satisfaction. The customer then provides an input of the level of customer satisfaction and comments for the selected ASCC provider and transfers the set of incentive vouchers to the ASCC center according to the level of customer satisfaction. The ASCC center then transfers the set of incentive ASCC voucher to the online GSP provider for making reward payment to the selected ASCC provider. In a preferred embodiment, the ASCC center further carries an insurance to pay the selected ASCC provider if the online GSP refuse or unable to make payment to the selected ASCC provider after performing the ASCC program for the online customer.

In summary a method for transferring electronic vouchers over a network system for defining and rewarding an after-sales service and customer care activity. In a preferred embodiment, the method further includes a step of transferring an incentive electronic voucher for payment of an assessment of customer satisfaction.

These and other objects and advantages of the present invention will no doubt become obvious to those of ordinary skill in the art after having read the following detailed description of the preferred embodiment which is illustrated in the various drawing figures.

### BRIEF DESCRIPTION OF THE DRAWINGS

FIG. 1 is an network system includes an online computer purchases goods or services from an online goods-or-services provider (GSP) ordering after-sales services from an ASCC center performed by an ASCC provider;,

FIGS. 2A and 2B is a flow chart showing the processing steps carried out by the all the parties involved in carrying out the after-sales service and customer care program;

FIGS. 3A to 3E are flow charts showing the processing steps carried out by all the on-line parties in carrying out the after-sales service and customer care program for different commercial situations.

FIG. 4 is a functional block diagram for illustrating a system configuration for server and associated database of an ASCC center provided to perform the ASCC program coordination and management.

### DETAILED DESCRIPTION OF THE PREFERRED EMBODIMENT

Reference is now made to the above listed Figures for the purpose of describing, in detail, the preferred embodiments of the present invention. The Figures referred to and the accompanying descriptions are provided only as examples of the invention and are not intended in anyway to limit the scope of the claims appended to the detailed description of the embodiment.

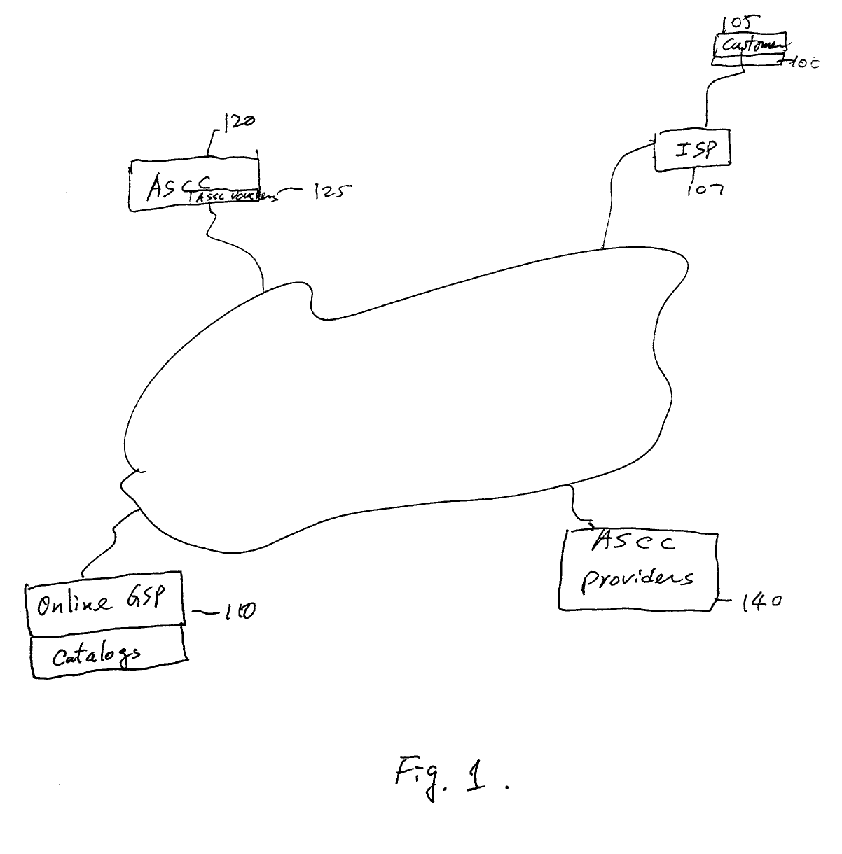

FIG. 1 is a functional block diagram of data communication network system 100, e.g., an Internet system or a wireless data transmission network. The network comprises an online customer 105 connected to the network communication system 100 with a personal computer (PC), or other network data-handling system, through an Internet service provider (ISP) 107. The ISP 107 receives a dial-up call from the customer 105 through a network interface device 106 and checks the user ID and password to allow the PC to log on to the ISP 106 and connected to the network system 100. The network system further includes an online goods and service provider (GSP) 110, preferably operating a online web-server with goods and service catalogs to allow the online customer to browse and carries out an online shopping. After survey the online catalog and live demonstrations provided by the online GSP 110, the customer 105 then selects the goods and services to purchase and carries out a check-out process by making payment to the online GSP 110.

The network system 100 further includes an after-sales service and customer care (ASCC) center 120 for issuing a set of electronic ASCC vouchers 125 over the network to the customer 105. With these electronic ASCC vouchers 125, the customer 105 can arrange with a selected after sales service and customer care (ASCC) provider 140 to perform the ASCC program according to the scope and process defined by the electronic vouchers submitted by the customer 105 to the ASCC provider 140. The ASCC provider can then submits the electronic ASCC vouchers received from the customer to the online GSP to receive payments for the services provided to the customer 105. The customer is further issues a set of incentive vouchers to reward the ASCC provider according to a level of customer satisfaction achieved by the ASCC provider 140. The payment schedule to the ASCC provider for the basic set of vouchers may be structured to provide only a small profit margin to the ASCC provider. The ASCC provider 140 receives a higher profit margin through the reward vouchers issued by the customer 105 with a high level of customer satisfaction. The process flow of the after sales service and customer care (ASCC) program is therefore well defined and each step can be tracked to assure the costs are under control while the customer is well taken of. Meanwhile, the online GSP 110 has access to a complete record of after sales service and customer care program to improve products and services and to develop long term good relationship with more online customers.

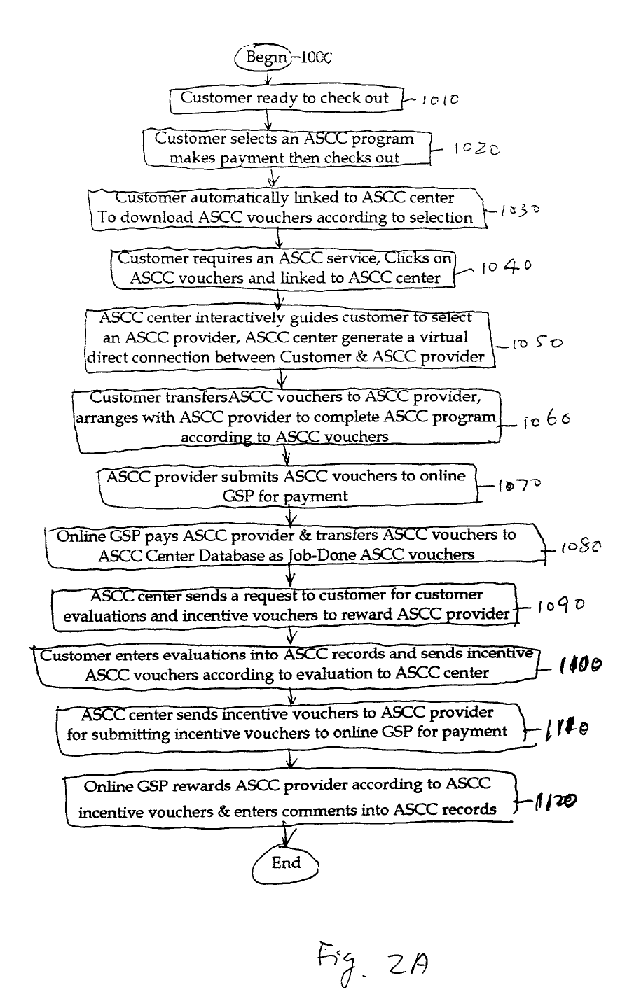

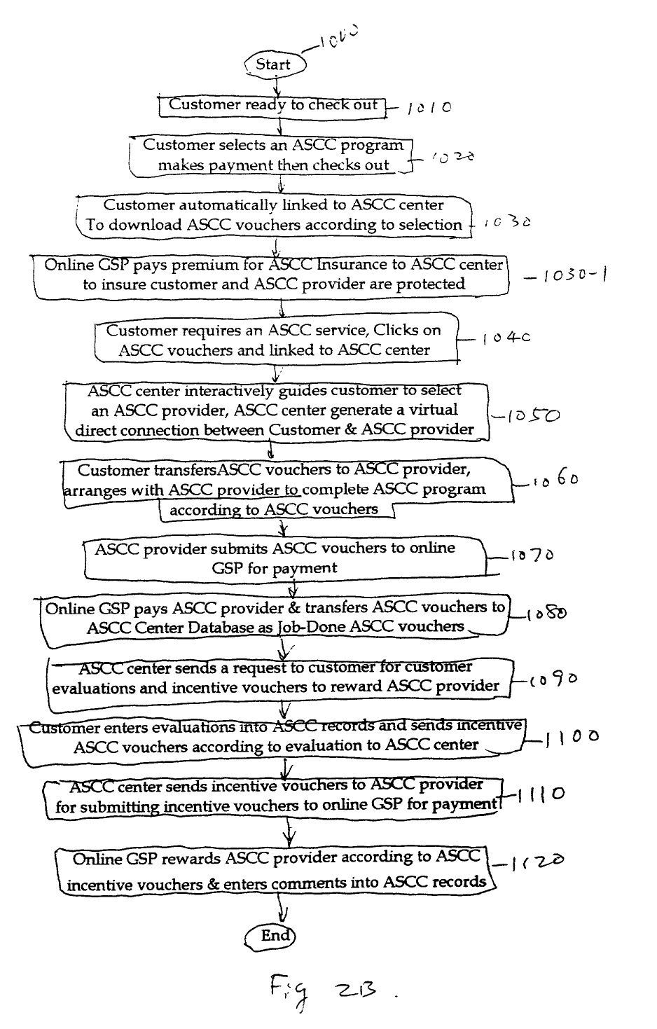

FIG. 2 is a flow chart for showing the interactive processing steps for an improved after-sales service and customer care (ASCC) program implemented with electronic ASCC vouchers transferred over the network 100 disclosed in this application. These processing steps are carried out by online interactions between all parties involved to assure the ASCC activities are carried out properly. These parties include a customer 105, an online goods and services provider (GSP) 110, an after sales service and customer care (ASCC) center 120, and an after-sales service and customer care provider (ASCP) 140 to complete the tasks of after sales service and customer care. The process begins (step 1000) with a customer 105 logs on an Internet web site of an online GSP 110 to select and order goods or services and is ready to check out (step 1010). Before beginning the payment processes, e.g., submitting credit card number followed by approving amount of payment, an after sales service and customer care (ASCC) catalog is presented to the customer to choose an after sales service and customer care (ASCC) program (step 1020). Some after sales service and customer care (ASCC) programs may be purchased with a price. While the basic service program, e.g., customer is free to return the ordered items purchased online within thirty days, is offered as a default of the ASCC program free of charge. Then the online customer 105 checks out and makes payment for the ordered items. The payment includes a payment for the selected ASCC program if an ASCC program other than the default free program is selected. Upon completion of payment process, the customer is automatically linked to an after-sales service and customer care (ASCC) center 120 to download the after-sales service and customer care (ASCC) electronic vouchers 125 (step 1030). As the customer 105 downloads the ASCC electronic vouchers, the customer may also be asked if the vouchers should provide an automatically reminder of certain important date such as a deadline of thirty days (or fifteen days) to return the ordered goods or cancellation of ordered services without charge. The customer may select to download the vouchers with or without such reminder options. For the purpose of brevity, a term “ASCC voucher will be used below and that term can represent either an electronic ASCC voucher or a paper ASCC voucher printed from a computer or issued by the ASCC center 120. Under most circumstances, electronic ASCC vouchers are more convenient because such vouchers can be transferred online and can be clicked for activating a link to the ASCC center 120.

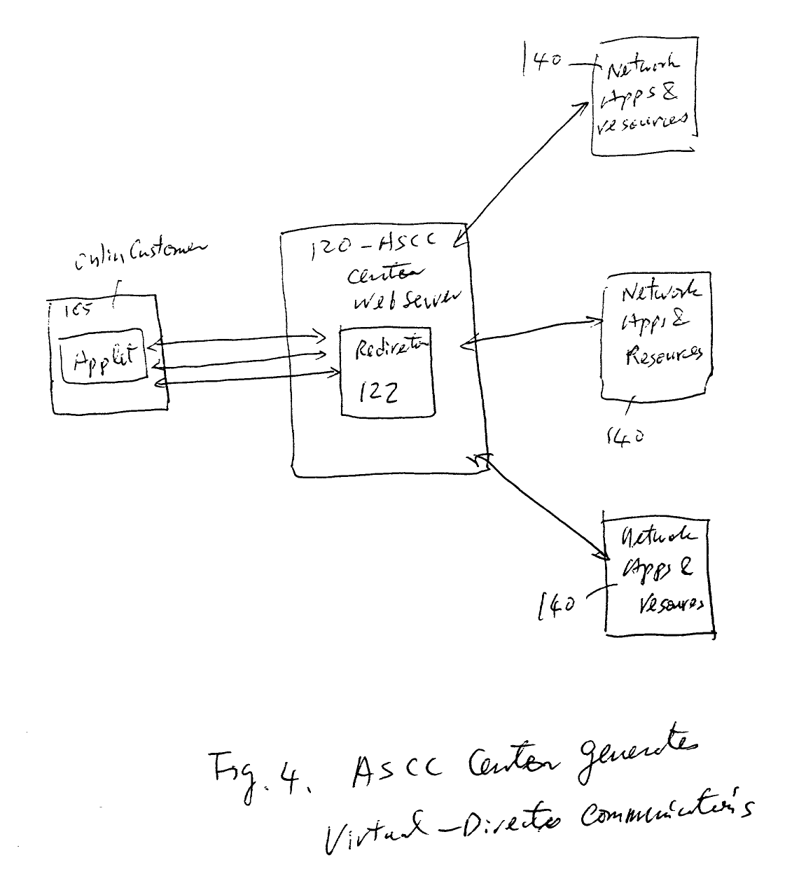

At a time when the situation arises that the customer 105 requires an after-sales service and customer-care (ASCC), the customer can simply click on one of the ASCC vouchers 125 for linking to the ASCC center 120 (step 1040). The ASCC center 120 interactively guides the customer 105 to select an ASCC provider 140 to perform the ASCC processes (step 1050). Meanwhile, the customer 105 is provided with options to purchase additional ASCC vouchers for additional ASCC options. In this step, the ASCC center 120 has an option to either sell the ASCC vouchers directly to the customer 105. The ASCC center may also provide a virtual-direct online interaction between the customer 105 and the online goods and services providers (GSPs) 110 to allow the customer to purchase additional ASCC vouchers directly from the online GSP and to choose different kinds of ASCC options. Some specific examples of these ASCC options will be discussed below. When an ASCC provider 140 is selected, the ASCC center 120 generates a “virtual direct” interaction between the customer 105 and the ASCC provider 140 for the customer to confirm an ASCC order by submitting the ASCC vouchers (see FIG. 4 below). According to the confirmed ASCC vouchers submitted by the customer 105, the ASCC provider 140 carries out the tasks required to take care of the need of the customer 105 (step 1060).

After the ASCC tasks are completed, the ASCC provider submits the ASCC vouchers to the online GSP to request for the payment from the online GSP for performing the ASCC tasks according to the vouchers (step 1070). As the online GSP receives the vouchers, a payment is made to the ASCC provider 140. Meanwhile, a click on one of these vouchers establishes a link to the ASCC center 120 (step 1080) for transferring the vouchers to the database 120-DB of the ASCC center 120 as a “job-done ASCC vouchers” stored into the database as an ASCC record. With these ASCC job-done ASCC vouchers, the ASCC center 120 then sends a request to the customer 105 for customer's evaluation for the service quality of the ASCC provider 140 in carrying out the ASCC tasks (step 109O). The customer 105 is also asked to submit a reward voucher if the customer 105 considers that the ASCC provider 140 deserve a reward when the ASCC processes are carried out with high quality. The customer 105 can also review the descriptions of the ASCC tasks performed by the ASCC provider 140 and enters customer's comments regarding these ASCC records entered by the ASCC provider 140 (step 1100). The online GSP 110 may also reward the ASCC provider 140 with incentive vouchers if the ASCC provider 140 provide a high quality service to the customer 105. These records are entered into the database of the ASCC center 120-DB and available for review by the online GSP 110, the ASCC provider 140, the customer 105. These records are also made available for another customer to review and use as a reference in selecting an ASCC provider to carry out the ASCC processes (step 1100). The ASCC center 120 then sends the reward voucher to the ASCC provider 140 for submitting the incentive vouchers to the online GSP for payment (step 1110). The online GSP 110 for the online GSP to make reward payment to the ASCC provider 140 for rewarding a job well done (step 1120).

The amounts of payment for different kinds of vouchers to the ASCC providers 140 may be structured to provide significant incentive for the ASCC provider 140 to carefully and diligently carry out the ASCC tasks. The customer 105 is enabled to have more control by rewarding the ASCC provider 140 for a job well done or to withhold the reward when the customer 105 is not satisfied with quality of the after sales services and customer care (ASCC). In the meantime, the vouchers along with the service records and comments stored in the database of the ASCC center 120 serve the function for tracking and maintaining a record of all the after sales services and customer care (ASCC) activities. The online GSP now receives the benefits that the process and cost structures of the ASCC operations are well defined and the customers are taken care of with clearly defined procedures. The after sales services and customer care records further provide valuable information for product and service improvement and for early detection and correction of design errors or product defects when large number of specific ASCC activities occur for a particular product. The customer 105 is served with clearly defined ASCC procedures without having to make repeated calls to the sellers not knowing what and when the ASCC processes will be completed. The vouchers, each with a unique alphanumeric designation is now used as an after-sales service and customer care identification (ASCC-ID) to keep track and to provide clear status of the developments of each step of the ASCC processes. Also, the customer 105 has the flexibility to select a local ASCC provider such that a visit can be made easily to assure each of the order ASCC tasks are performed timely and according to standards specified in the vouchers.

To further assure that a customer's and the ASCC provider's interests are properly protected, the ASCC center 120 may carry an ASCC insurance. The ASCC insurance is to compensate the financial losses of a customer or an ASCC provider when the online GSP refuse to pay the customer for the returning goods or cancellation of services, or refuse to pay the ASCC providers for the ASCC and reward vouchers. A small amount of insurance premium may be required from each online GSP at the time when the customer purchase the goods and services and registered with the ASCC center 120 to download the ASCC vouchers (step 1030-1) as that shown in FIG. 2B. With an insurance coverage, the customers and the ASCC providers are protected that the after-sales services and customer care programs as promised by the online GSP will be properly compensated in case the online GSP refuses or cannot fulfill the promises. Again, with the vouchers for tracking the ASCC activities and service records now stored in the ASCC database 120-DB, an insurance claim can be definitely and specifically documented. With such insurance program, a customer would become more confident to conduct an online transaction with less concern that the online GSP would not or cannot honor the promises made at the time of an online purchase. The ASCC provider is also assured that a payment for ASCC performance and potential rewards will be paid even if the online GSP would not or cannot pay in the future. The electronic commerce will be enhanced when the interests of the parties involved are all properly protected.

### EXAMPLE 1

### Customer Returning an Ordered Item

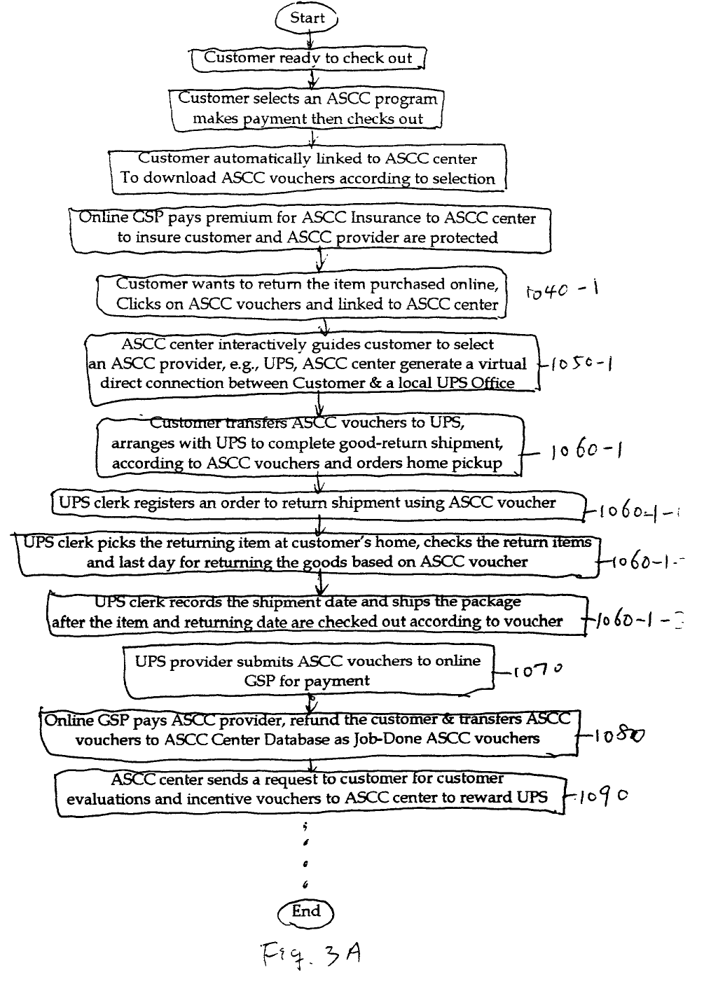

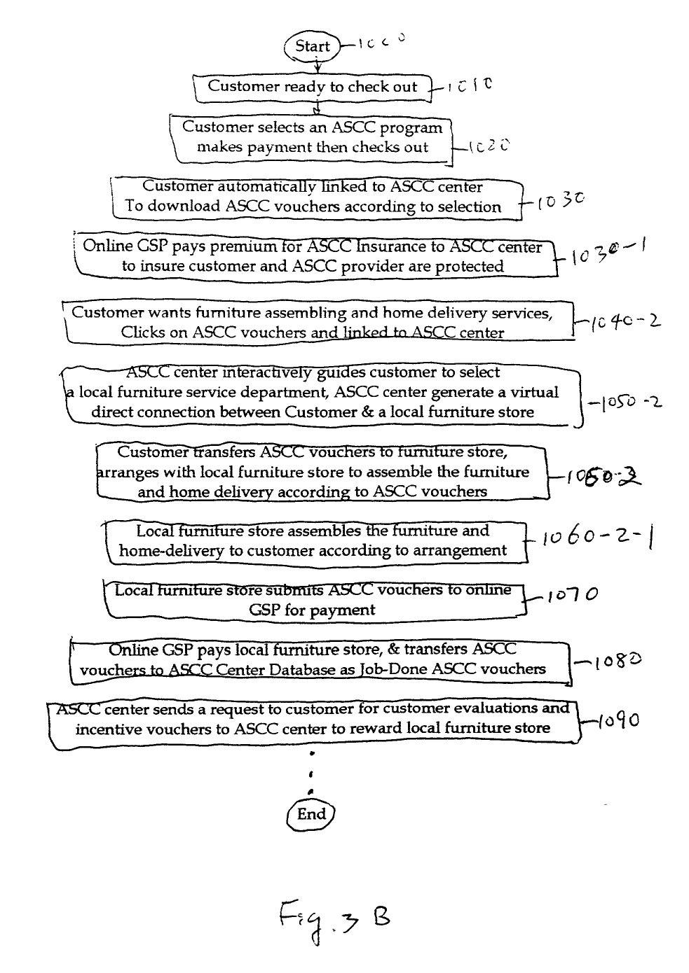

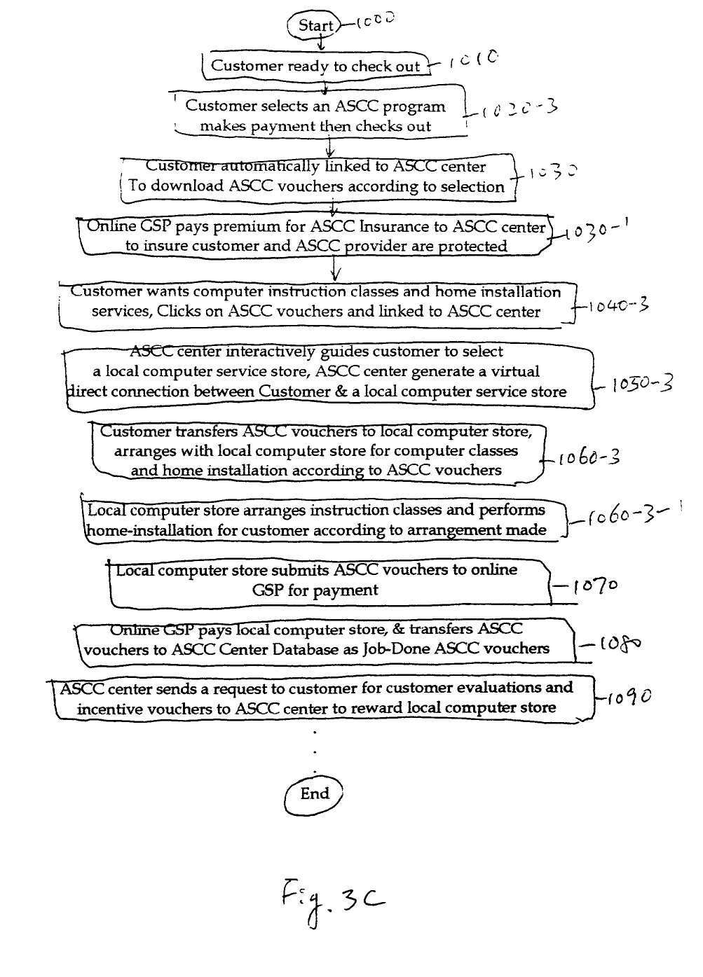

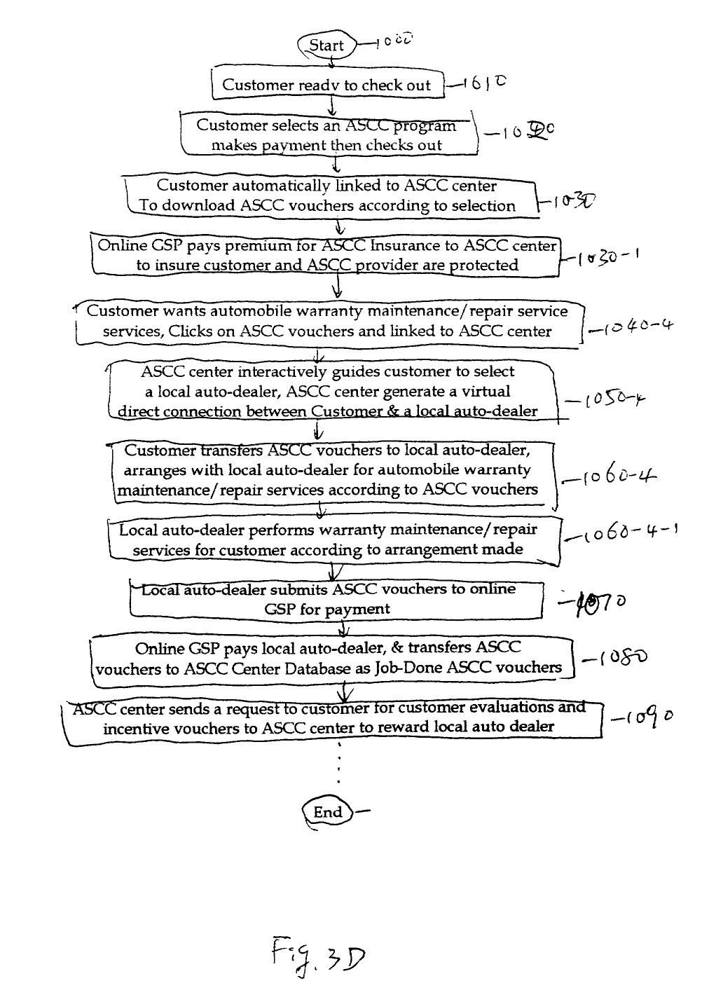

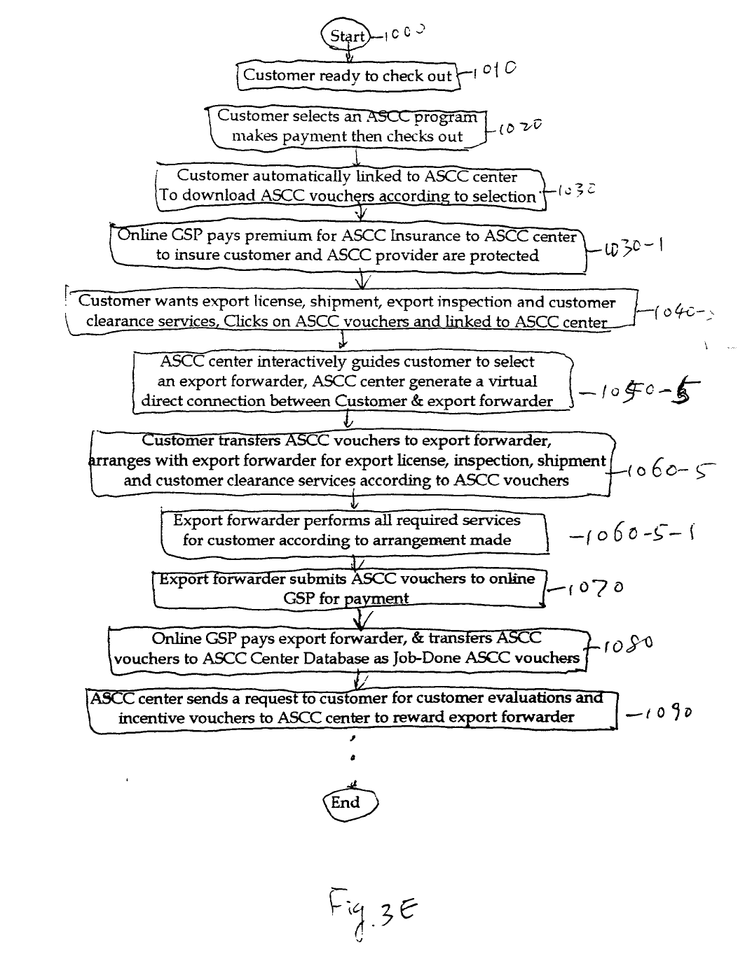

Referring to FIG. 3A for steps carried out for completing the tasks of customer returning an ordered item. As the customer 105 decides to return the ordered item purchase on line, an ASCC program begins by clicking on an ASCC voucher 125 as that described above in step 1040-1 and the customer is linked to the ASCC center 120 through Internet. As an example, the customer 105 is guided by the ASCC center 120 to choose a shipping company to ship back the ordered item by Federal Express, the United Parcel Service (UPS), Airborne Express, or DHL. The customer 105 may choose a shipping company, e.g., UPS. The ASCC center 120 establishes a virtual direct connection between the customer 105 and the ASCC provider 140, e.g., UPS, for the customer 105 to transfer the ASCC voucher to UPS (step 1050-1). The customer 105 then choose a date for delivering the returning item to UPS for shipping back to the online GSP 110 (step 1060-1). The ASCC voucher provide a tracking ID and a description of the returning item for shipment by UPS. When the customer 105 enters into the UPS office, the record for shipment is already prepared with clear specification of what are to be shipped according to the information provided through the ASCC voucher (step 1060-1-1). The UPS clerk then checks the returning item (step 1060-1-2) and seal the package while entering a shipment data record for the ASCC voucher (step 1060-1-2). According to the agreement between the ASCC provider and the online GSP, the ASCC provider may provide specific services for the online GSP to assure the returning item is according to certain specific conditions. For instance, the UPS clerk will check the packing list to make sure the returning item delivered by the customer includes all the pieces according to the packing list provided by the ASCC voucher (1060-1-3). Meanwhile, if the returning item is delivered to the UPS over a thirty-day limit, the UPS clerk can refuse to ship the item based on the conditions listed on the ASCC voucher 125 (step 1060-1-3). A record for refusing to ship the returned item can be entered and the record sent to the online GSP 110 and receive an award from the online GSP 110. Therefore, there would be less unnecessary disputes between the online GSP and the customer 105 because the ASCC voucher now clearly defines the conditions for returning the ordered item. Meanwhile, the alphanumeric ID of the ASCC voucher 125 can be used by the customer 105 to track if the online GSP receives the returning item and to make sure that the online GSP send out the refund according to the ASCC agreement defined in the ASCC vouchers (step 1080).

When a customer 105 is linked to a ASCC provider 140 such as UPS, the customer may select additional services such as home pickup, or UPS' staff to repackage the returning item (1060-1-1). Such services may be selected by paying additional service fee directly to the ASCC provider 140 with ASCC center 120 generates a virtual direct interaction between the customer and the ASCC provider. These activities will be recorded and transferred to the online GSP 110 by the ASCC center 120 such that the records of returning item can be anticipated and processed soon as the returning item is received by the online GSP 110 the designated location. The customer 105 does not have to wait for long period of time for the refund because the record of the process for returning the item can be sent online even before the returning item is received by the online GSP. The customer 105 now is provided with greater degree of freedom to order different level of ASCC options depending on customer's circumstances at the time when a decision is made to return the ordered item. Since the process is well defined and the ASCC voucher is employed to carry out these procedures, the frustrations now encountered by an online customer not knowing how and what to do for returning the ordered item to the online GSP is resolved. Furthermore, with an incentive voucher to reward UPS for efficient services with respect and courtesy, the customer is provided with more control to encourage good services provided by the ASCC provider 140.

### EXAMPLE 2

### Customer Orders Services for Assembling and Delivery of Furniture

As the customer 105 orders furniture online, FIG. 3B shows the steps for a customer to order a service of assembling and then delivering the furniture such that the customer 105 receives an assembled furniture instead of box of furniture pieces waiting to be assembled. As the customer 105 check out the furniture from an online furniture store, she may purchase an ASCC program (step 1040-2) for an ASCC provider to carry out these tasks for her. The ASCC center 120 provides to the customer 105 several local ASCC providers trained and qualified by furniture dealers to assemble and deliver the furniture. The customer selects one ASCC provider and sends the voucher to the ASCC provider (step 1050-2) such that the unassembled furniture package may be first delivered to the ASCC provider 140 (step 1060-2). The ASCC provider 140 then assemble and deliver the furniture to the customer 105 according to the voucher and the mutually agreed date and time (step 1060-2-1). The customer is well served. The electronic commerce is enhanced with such service because the customer is no longer left alone without help when a furniture dealer is far away and access to customer service is very difficult and often are not too useful when communication is carried out on a telephone. The ASCC voucher together with the reward voucher now managed by the ASCC center 120 provide systematic framework to trace and enhance high quality ASCC activities are carried out with clearly defined processes such that all parties involved are benefited from the electronic commerce.

### EXAMPLE 3

### Customer Orders Computer Instruction Course, and Home Installation Services

Under the circumstance a customer is unfamiliar with the use of computer, the customer 105′ may go to a local computer store, such as Fry's, Micro Center, etc., to purchase a computer for the first time. In FIG. 3C, a sales agent then logs on to ASCC center 120 on behalf of the customer to select the ASCC programs (step 1020-3). The customer unfamiliar with computer signs up an ASCC program includes a personal computer instruction course with a local community college and a home installation service (step 1040-3). The sales agent of the computer store prints the ASCC vouchers issued by the ASCC center 120 for the customer 105′ (step 1050-3). With that voucher, the customer 105′ may go to the community college to register for a computer course to learn the basic skill for using the computer and calls the local computer service store to perform a home installation to begin use the computer (step 1050-3). Then the customer 105′ may log on to the ASCC center. The customer 105′ may submit incentive vouchers for the community college and the home installation local ASCC provider 140 to reward them for a job well done. Or, on the other hand, if the quality of the ASCC activities is not satisfactory, the customer may withhold the incentive vouchers. Furthermore, the customer may enter comments to critique the services provided by the community college if the instruction course is not useful or the quality of the home installation is not up to customer's expectation. With the incentive vouchers and the public forum conveniently provided by the ASCC center, the customer, even unfamiliar with the use of computer, is enabled to manage and control the ASCC activities to receive more satisfactory services with experiencing undue frustration as now faced by many online shoppers.

### EXAMPLE 4

### Customer Orders A Warranty Maintenance/Repair Service for A Computer (or An Automobile)

As the customer 105 needs to have a warranty maintenance or repair service for a computer or automobile, the customer 105 can easily click on the ASCC voucher to link to the ASCC center 120 (step 1040-4). The ASCC center then presents several local resources, e.g., several local computer maintenance/repair shops (or automobile dealers) (step 1050-4). The customer 105 has an option to review comments and service history files for each of these local resources for past performance as an ASCC provider (step 1050-4). The customer can then selects a computer shop (or an automobile dealer) to carry out the warranty maintenance or repair job (step 1050-4). The ASCC center 120 then generate a virtual direct interaction session between the customer and the ASCC provider 140 (step 1050-4). The customer 105 submits the ASCC voucher 125 to the ASCC provider (step 1060-4) and arranges schedule and process for the ASCC provider, e.g., the computer repair shop/automobile dealer, to carry out the warranty maintenance/repair work (step 1060-41). After the warranty maintenance/repair is completed, the ASCC provider submits the voucher to the online GSP, e.g., Compaq Computer (or Ford Automobile Company) to receive payment (step 1070). The ASCC center 120 is notified that the ASCC activities are completed with certain vouchers. And, the ASCC center 120 then sends a request to the customer 105 to ask for customer's approval to provide incentive voucher to the ASCC provider, e.g., a computer shop or an automobile dealer (step 1080). The incentive voucher is used to reward the ASCC provider for a job well done if the customer 105 is pleased with the services. The ASCC center also asks the customer to enter evaluations and comments about the quality and timeliness or other aspects of the ASCC processes performed by each of the local ASCC providers (step 1090). These records will become references for other customer to select their own ASCC providers in the future.

FIGS. 3A to 3D are only few examples of ASCC programs that implemented according to the system and method disclosed in this invention. The ASCC program may be employed for many other types of transactions that involves after-sales services and customer cares provided by either by third party ASCC providers or even the staffs of the online goods and services provides (GSP). The ASCC vouchers serve several useful functions for all the parties involved. A seller of goods and services has a well-defined method to quantify the costs of different processes for after sales services and customer cares. The seller is also benefited from the facts that a long term relationship is established with customers by taking care of their needs after the transaction is completed. A record is kept and made available for all the after sales services and customer care activities. The records become valuable information data bank for accessing product reliability, service quality of different ASCC providers and customer profiles for market advertisement and direction for future product development. The records that is kept as semi-public database are also an effective tool to monitor and regulate the ASCC providers to encourage high quality service and good customer cares.

### EXAMPLE 5

### Customer Purchases Goods that Requires Shipment, Export License and Customer Clearance for International Shipment

As the customer 105 purchases a turbine-generator for a power plant that requires shipment to the harbor, export license and export inspection for clearing the customer office (step 1040-5 of FIG. 3E). Finance arrangements through banking institutes and international shipment with insurance must also be arranged for shipping the ordered item to a foreign nation. Again, the ASCC a customer is linked to the ASCC center 120 for selecting an ASCC provider, e.g., a bank and an export forwarder, to take care of these processes (step 1050-5). The ASCC vouchers issued by the ASCC center 120 are pre-arranged as part of transaction package by the GSP, i.e., the seller of the turbine generator. Therefore, these vouchers also provide clear instructions for carrying out each step. Furthermore, the ASCC center 120 now generate a direct virtual link between the customer and the ASCC providers such that the processes are simplified with all documents and required procedures clearly defined and pre-processed online by computers. Just as the after sales services and customer care activities for individual buyer, a business customer in this case is also enabled to trace the development of each step by use of the voucher number and to reward the bank or exporter for a high quality service. In addition to the above examples, the ASCC vouchers can also be used in different types of commercial transactions such as the after sales services and customer care of establishing a tile escrow and setting up a home mortgage with a bank. These types of after sales services would be required when a real estate transaction is completed for sales without the assistance of a real estate broker.

FIG. 4 show a functional block diagram for illustrating a virtual direct network communication between an online customer 105 and an ASCC provider 140. The ASCC center 120 is implemented as a web server 120 and the online customer 105 is now communicating to the ASCC center through an Applet. The Applet is now received by a network communication redirecting means 122. The Applet is then re-directed to one of the several ASCC providers 140 represent as a network application-and-resources. The network communication redirecting means can be a stream-socket connection processor implemented in the web server for the ASCC center 120. With the network communication redirecting means 122, implementing the stream-socket connection processor, the ASCC center 120 can generate a virtual direct communication between the customer 105 and one of the ASCC providers 140. The technical details can be further referenced to the U.S. Pat. No. 5,987,523 and that patent is hereby incorporated by reference. Even that the virtual direct communication is provided by the ASCC center in each of above examples, the invention disclosed by the Patent Application can be implemented without the use of this network communication technique. However, it is recognized that the virtual direct communication provided by the ASCC center web server greatly enhance the convenience and flexibility of the customer 105 to transfer of ASCC vouchers and arrange ASCC programs defined by the ASCC vouchers. Also, the ASCC vouchers can also be issued and managed by the online GSP directly without the ASCC center as described above. But again, the ASCC center provides a valuable service with data records and public access to objectively and effectively coordinates and manages the after-sales service and customer care program whereby the consumer benefits are better protected.

Based on FIGS. 1 to 4 and above descriptions, this invention discloses a network system connected with an online goods and services provider (GSP) 110 selling goods-or-services to an online customer 105 through the network system. The network system further includes an after-sales-service and customer care (ASCC) center 120 for issuing an electronic ASCC voucher defining an ASCC program related to sales of the goods-or-services wherein the electronic ASCC vouchers are provided for transmitting over the network. In a preferred embodiment, the network system further includes an after-sales-service and customer care (ASCC) 140 provider connected to the network for receiving the electronic service voucher transmitted over the network for carrying out the ASCC program for the customer. In a preferred embodiment, the after-sales-service and customer care (ASCC) center is further provided to issue an incentive voucher for enabling the customer to reward the ASCC provider according to a customer satisfaction assessment by the customer. In another preferred embodiment, the after-sales-service and customer care (ASCC) center further includes a virtual-direct network communicating means 122 for enabling a virtual-direct network communication between the online customer and the ASCC provider to arrange for the ASCC program and for transmitting the ASCC voucher over the network. In another preferred embodiment, the virtual-direct network-communication means 120 further comprises a stream-socket means. The stream socket means is for providing stream-sockets for connecting network messages transmitted between the online customer and the ASCC center and between the ASCC provider and the ASCC center to establish a stream-socket connected direct communication between the online customer and ASCC provider. In another preferred embodiment, the network system is a wireless network system. The network system further includes an after-sales-service and customer care (ASCC) center further includes an ASCC database for keeping a record related to the ASCC program. The ASCC database further includes database manager for organizing the record kept in the ASCC database according to the online GSP, the online customer and the ASCC provider.

This invention further discloses a method of selling goods-or-service by an online goods and services provider (GSP) to an online customer through a network system. The method includes steps of a) the online GSP issuing an electronic ASCC voucher for defining an ASCC program related to sales of the goods-or-services and for transmitting the electronic ASCC vouchers over the network. In another preferred embodiment, the method further includes a step of connecting an after-sales-service and customer care (ASCC) provider to the network for receiving the electronic service voucher transmitted over the network for carrying out the ASCC program for the customer. In another preferred embodiment, the the step of issuing the electronic ASCC voucher further comprises a step of issuing an incentive voucher for enabling the customer to reward the ASCC provider according to a customer satisfaction assessment by the customer. In another preferred embodiment, the method further includes a step of providing to the online GSP a virtual-direct network communicating means for enabling a virtual-direct network communication between the online customer and the ASCC provider to arrange for the ASCC program and for transmitting the ASCC voucher over the network.

In summary, this invention discloses a method for carrying out an online electronic commerce. The method includes a step of transmitting an electronic voucher over a network system for defining and rewarding an after-sales service and customer care (ASCC) activity related to the electronic commerce. In another preferred embodiment, the method further includes a step of transmitting an electronic ASCC incentive voucher for rewarding an ASCC provider performing the ASCC activity according a customer assessment of an ASCC satisfaction level.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

I claim:

1. A network system connected with an online goods and services provider (GSP) selling goods-or-services to an online customer through the network system, the network system further comprising
an after-sales-service and customer care (ASCC) center for issuing an electronic ASCC voucher defining an ASCC program related to sales of said goods-or-services wherein said electronic ASCC vouchers are provided for transmitting over said network.

2. The network system of claim 1 further comprising:
an after-sales-service and customer care (ASCC) provider connected to said network for receiving said electronic service voucher transmitted over said network for carrying out said ASCC program for said customer.

3. The network system of claim 2 wherein:
said after-sales-service and customer care (ASCC) center is further provided to issue an incentive voucher for enabling said customer to reward said ASCC provider according to a customer satisfaction assessment by said customer.

4. The network system of claim 2 wherein:
said after-sales-service and customer care (ASCC) center further includes a virtual-direct network communicating means for enabling a virtual-direct network communication between said online customer and said ASCC provider to arrange for said ASCC program and for transmitting said ASCC voucher over said network.

5. The network system of claim 4 wherein:
said virtual-direct network-communication means further comprises a stream-socket means for providing stream-sockets for connecting network messages transmitted between said online customer and said ASCC center and between said ASCC provider and said ASCC center to establish a stream-socket connected direct communication between said online customer and ASCC provider.

6. The network system of claim 2 wherein:
an after-sales-service and customer care (ASCC) center further includes an ASCC database for keeping a record related to said ASCC program.

7. The network system of claim 2 wherein:
said ASCC database further includes database manager for organizing said record kept in said ASCC database according to said online GSP, said online customer and said ASCC provider.

8. A network system connected with an online goods and services provider (GSP) selling goods-or-services to an online customer through the network system, wherein:
said online GSP further includes an electronic ASCC voucher issuing means for issuing an ASCC voucher for defining an ASCC program related to sales of said goods-or-services wherein said electronic ASCC vouchers are provided for transmitting over said network.

9. The network system of claim 8 further comprising:
an after-sales-service and customer care (ASCC) provider connected to said network for receiving said electronic service voucher transmitted over said network for carrying out said ASCC program for said customer.

10. The network system of claim 9 wherein:
said electronic voucher issuing means further provided to issue an incentive voucher for enabling said customer to reward said ASCC provider according to a customer satisfaction assessment by said customer.

11. The network system of claim 9 wherein:
said online GSP further includes a virtual-direct network communicating means for enabling a virtual-direct network communication between said online customer and said ASCC provider to arrange for said ASCC program and for transmitting said ASCC voucher over said network.

12. The network system of claim 11 wherein:
said virtual-direct network-communication means further comprises a stream-socket means for providing stream-sockets for connecting network messages transmitted between said online customer and said ASCC center and between said ASCC provider and said ASCC center to establish a stream-socket connected direct communication between said online customer and ASCC provider.

13. The network system of claim 9 wherein:
said electronic ASCC voucher issuing means further includes an ASCC database for keeping a record related to said ASCC program.

14. The network system of claim 9 wherein:
said ASCC database further includes database manager for organizing said record kept in said ASCC database according to said online customer and said ASCC provider.

15. A network system connected with an online goods and services provider (GSP) selling goods-or-services for conducting an electronic commerce (e-commerce) transaction on said network wherein said network system further comprising
an electronic after-sales-service and customer care (ASCC) voucher transmitted over said network having an ASCC voucher identifier unique to said e-commerce transaction for defining and tracking an after-sales service and customer care (ASCC) program.

16. The network system of claim 15 further comprising
an online customer receiving said electronic ASCC voucher from said network for activating said ASCC program.

17. The network system of claim 15 further comprising
an after-sales-service and customer care (ASCC) provider to receive said electronic ASCC voucher transmitted over said network for performing said ASCC program defined and tracked by said electronic ASCC voucher.

18. The network system of claim 15 further comprising
an after-sales-service and customer care (ASCC) center for issuing said electronic ASCC voucher and for coordinating and tracking said ASCC program.

19. The network system of claim 18 wherein:
said ASCC center further includes an ASCC database for recording data related to said ASCC program.

20. The network system of claim 18 further comprising:
an online customer carrying out said e-commerce transaction with said online GSP and receiving said electronic ASCC voucher from said ASCC center for activating said ASCC program;
an after-sales-service and customer care (ASCC) provider;
said ASCC center further includes a virtual-direct network communication means for enabling a virtual-direct network communication between said online customer and said ASCC provider for transmitting said ASCC voucher over said network to said ASCC provider to arrange for carrying out said ASCC program defined and track by said ASCC voucher.

21. The network system of claim 15 wherein:
an after-sales-service and customer care (ASCC) center for issuing said electronic ASCC voucher and for coordinating, tracking and carrying an insurance policy for said ASCC program.

22. A network system connected with an online goods and services provider (GSP) selling goods-or-services to an online customer through the network system, the network system further comprising
an after-sales-service and customer care (ASCC) center for issuing an electronic ASCC voucher defining an ASCC program related to sales of said goods-or-services wherein said electronic ASCC vouchers are provided for transmitting over said network;
a plurality of after-sales-service and customer care (ASCC) providers connected to said network;
said ASCC center having an ASCC database for storing a record for each of said ASCC providers for allowing said online customer to review and to chose a selected ASCC provider;
said ASCC center further includes a virtual-direct network communicating means for enabling a virtual-direct network communication between said online customer and said selected ASCC provider to arrange for said ASCC program and for said online customer to transmit said ASCC voucher to said selected ASCC provider over said network; and
said after-sales-service and customer care (ASCC) center is further provided to issue an incentive voucher for enabling said online customer to reward said selected ASCC provider according to a customer satisfaction assessment by said customer.

23. The network system of claim 1 wherein:
said network system is a wireless system.

24. The network system of claim 8 wherein:
said network system is a wireless system.

25. The network system of claim 15 wherein:
said network system is a wireless system.

26. The network system of claim 22 wherein:
said network system is a wireless system.

27. A method of selling goods-or-service by an online goods and services provider (GSP) to an online customer through a network system comprising
connecting an after-sales service and customer care center to said network for issuing an electronic ASCC voucher for defining an ASCC program related to sales of said goods-or-services and for transmitting said electronic ASCC vouchers over said network.

28. The method of claim 27 further comprising:
connecting an after-sales-service and customer care (ASCC) provider to said network for receiving said electronic service voucher transmitted over said network for carrying out said ASCC program for said customer.

29. The method of claim 28 wherein:
issuing an incentive voucher for enabling said customer to reward said ASCC provider according to a customer satisfaction assessment by said customer.

30. The method of claim 28 wherein:
providing to said after-sales-service and customer care (ASCC) center a virtual-direct network communicating means for enabling a virtual-direct network communication between said online customer and said ASCC provider to arrange for said ASCC program and for transmitting said ASCC voucher over said network by.

31. The method of claim 30 wherein:
providing to said virtual-direct network-communication means a stream-socket means for providing stream-sockets for connecting network messages transmitted between said online customer and said ASCC center and between said ASCC provider and said ASCC center to establish a stream-socket connected direct communication between said online customer and ASCC provider.

32. The method of claim 28 wherein:
keeping a record related to said ASCC program in an ASCC database.

33. The method of claim 32 wherein:
employing a database manager for organizing said record kept in said ASCC database according to said online GSP, said online customer and said ASCC provider.

34. A method of selling goods-or-service by an online goods and services provider (GSP) to an online customer through a network system comprising
said online GSP issuing an electronic ASCC voucher for defining an ASCC program related to sales of said goods-or-services and for transmitting said electronic ASCC vouchers over said network.

35. The method of claim 34 further comprising:
connecting an after-sales-service and customer care (ASCC) provider to said network for receiving said electronic service voucher transmitted over said network for carrying out said ASCC program for said customer.

36. The method of claim 35 wherein:
said step of issuing said electronic ASCC voucher further comprises a step of issuing an incentive voucher for enabling said customer to reward said ASCC provider according to a customer satisfaction assessment by said customer.

37. The method of claim 35 further comprising a step of:
providing to said online GSP a virtual-direct network communicating means for enabling a virtual-direct network communication between said online customer and said ASCC provider to arrange for said ASCC program and for transmitting said ASCC voucher over said network.

38. The method of claim 37 wherein:
said step of providing to said online GSP a virtual-direct network communicating means further comprises a step of providing a stream-socket means for providing stream-sockets for connecting network messages transmitted between said online customer and said ASCC center and between said ASCC provider and said ASCC center to establish a stream-socket connected direct communication between said online customer and ASCC provider.

39. The method of claim 35 further comprising a step of:
keeping a record related to said ASCC program in an ASCC database.

40. The method of claim 39 further comprising a step:
providing a database manager for organizing said record kept in said ASCC database according to said online customer and said ASCC provider.

41. A method of conducting an electronic commerce (e-commerce) transaction for selling goods-or-services on a network system by an online goods and services provider (GSP) comprising
transmitting an electronic after-sales-service and customer care (ASCC) voucher over said network having an ASCC voucher identifier unique to said e-commerce transaction for defining and tracking an after-sales service and customer care (ASCC) program.

42. The method of claim 41 further comprising
receiving said electronic ASCC voucher by an online customer from said network for activating said ASCC program.

43. The method of claim 41 further comprising
connecting an after-sales-service and customer care (ASCC) provider to said network for receiving said electronic ASCC voucher transmitted over said network for performing said ASCC program defined and tracked by said electronic ASCC voucher.

44. The method of claim 41 further comprising
connecting an after-sales-service and customer care (ASCC) center to said network for issuing said electronic ASCC voucher and for coordinating and tracking said ASCC program.

45. The method of claim 44 further comprising:
providing to said ASCC center an ASCC database for recording data related to said ASCC program.

46. The method of claim 44 further comprising:
transmitting said electronic ASCC voucher from said ASCC center to an online customer after said online customer completing said e-commerce transaction with said online GSP for said online customer to activate said ASCC program;
connecting an after-sales-service and customer care (ASCC) provider to said network;
providing to said ASCC center a virtual-direct network communication means for enabling a virtual-direct network communication between said online customer and said ASCC provider for transmitting said ASCC voucher over said network to said ASCC provider to arrange for carrying out said ASCC program defined and track by said ASCC voucher.

47. The method of claim 44 further comprising:
carrying an insurance policy by said ASCC center for said ASCC program.

48. A method of selling goods-or-service by an online goods and services provider (GSP) to an online customer through a network system comprising:
connecting an after-sales-service and customer care (ASCC) center to said network for issuing an electronic ASCC voucher defining an ASCC program related to sales of said goods-or-services;
connecting a plurality of after-sales-service and customer care (ASCC) providers to said network;
providing an ASCC database in said ASCC center for storing a record for each of said ASCC providers for allowing said online customer to review and to chose a selected ASCC provider;
providing to said ASCC center a virtual-direct network communicating means for enabling a virtual-direct network communication between said online customer and said selected ASCC provider to arrange for said ASCC program and for said online customer to transmit said ASCC voucher to said selected ASCC provider over said network; and
said ASCC center further issuing an incentive voucher to said online customer for enabling said online customer to reward said selected ASCC provider according to a customer satisfaction assessment by said customer.

49. A method for carrying out an online electronic commerce comprising a step of:
transmitting an electronic voucher over a network system for defining and rewarding an after-sales service and customer care (ASCC) activity related to said electronic commerce.

50. The method of claim 49 further comprising:
transmitting an electronic ASCC incentive voucher for rewarding an ASCC provider performing said ASCC activity according a customer assessment of an ASCC satisfaction level.
